(19) United States
(12) Patent Application Publication
(10) Pub. No.: US 2024/0192018 A1
(43) Pub. Date: Jun. 13, 2024

(54) SYSTEM AND METHOD FOR VIRTUAL LANE GENERATION

(71) Applicant: HERE Global B.V., Eindhoven (NL)

(72) Inventors: Bruce BERNHARDT, Wauconda, IL (US); Jingwei XU, Buffalo Grove, IL (US); Yan CHEN, Chicago, IL (US)

(21) Appl. No.: 18/077,072

(22) Filed: Dec. 7, 2022

(51) Int. Cl. G01C 21/00; G06F 16/29

(52) U.S. Cl. CPC G01C 21/3815; G01C 21/3848; G06F 16/29

(57) ABSTRACT

The disclosure provides a system and a method for virtual lane generation for a vehicle. The system may determine one or more paths associated with a lane pair of the vehicle. The lane pair may correspond to an ingress lane and an egress lane associated with a traffic signal intersection. The system may further aggregate the determined one or more paths corresponding to the lane pair, to generate a bounding path associated with the lane pair. The system may further generate a virtual lane based on the generated bounding path. The generation of the virtual lane may be based on determination of a plurality of lane shape points corresponding to the generated bounding path. The system may further store data associated with the generated virtual lane in a map database.

### TECHNOLOGICAL FIELD

The present disclosure generally relates to routing and navigation systems, and more particularly relates to systems and methods for updating lane data for routing and navigation applications.

### BACKGROUND

Typically, a road intersection, such as a traffic signal intersection or a non-signalized intersection consists of a plurality of connecting lanes, such as ingress and egress lanes. The vehicles passing through the road intersection should follow their respective lane paths in order to avoid causing inconvenience to other vehicles and to avoid accidents. Certain vehicles, such as autonomous vehicles (AVs) utilize sensors, such as camera for navigation assistance, such as for detection of lanes by identification of lane markings. However, such lane markings may be missed by the AVs, which may lead to occurrence of accidents. Conventionally, a driving mode of the AVs may need to be changed at the road intersection, due to inability of the AVs to travel within their respective lane paths which may lead to rise of safety concerns of the AVs and the nearby vehicles.

Therefore, it is required to provide a system for effective management of the traffic passing through the road intersection.

### BRIEF SUMMARY

The following presents a simplified summary in order to provide a basic understanding of some novel embodiments described herein. This summary is not an extensive overview, and it is not intended to identify key/critical elements or to delineate the scope thereof. Some concepts are presented in a simplified form as a prelude to the more detailed description that is presented later.

The present disclosure provides a system, a method, and a computer programmable product for virtual lane generation. The system may enable generation of the virtual lane for the vehicles, such as autonomous vehicles (AVs). Conventionally, the AVs may rely on sensor data for safe travel of the AVs. However, following a desired path of travel at the road intersection may be difficult for the AVs due to presence of the plurality of lanes. The system of the present disclosure may enable utilization of data associated with the generated virtual lane by the AVs for safely following the desired path between an ingress lane and an egress lane of a lane of the plurality of lanes. Moreover, the system of the present disclosure may provide verification of the path followed by the AVs. Thus, the system may further eliminate requirement of switching of driving mode of the AVs at the traffic signal intersection.

Example embodiments of the present disclosure provide a system, a method, and a computer program product for generating a virtual lane in order to overcome the challenges discussed above, and to provide the solutions envisaged as discussed above.

Some example embodiments disclosed herein provide a system for generation of a virtual lane, the system comprising a memory configured to store computer-executable instructions and one or more processors configured to determine one or more paths associated with a lane pair of the vehicle. The lane pair corresponds to an ingress lane and an egress lane associated with a traffic signal intersection. The at least one processor is further configured to aggregate the determined one or more paths corresponding to the lane pair, to generate a bounding path associated with the lane pair. The at least one processor is further configured to generate a virtual lane based on the generated bounding path. The generation of the virtual lane is based on determination of a plurality of lane shape points corresponding to the generated bounding path. The at least one processor is further configured to store data associated with the generated virtual lane in a map database.

According to some example embodiments, the at least one processor is further configured to identify the traffic signal intersection. Further, the at least one processor is configured to retrieve signal phase and timing (SPaT) data and map data associated with the identified traffic signal intersection. Furthermore, the at least one processor is configured to determine the lane pair based on the retrieved SPaT data and the map data. Further, the at least one processor is configured to retrieve historical sensor data associated with one or more vehicles passed through the determined lane pair. The at least one processor is configured to perform map matching of the retrieved historical sensor data and the determined lane pair to determine the one or more paths associated with the lane pair of the vehicle.

According to some example embodiments, the generation of the virtual lane is further based on a determination of a lane curvature associated with the generated bounding path.

According to some example embodiments, the generated bounding path further comprises a first boundary and a second boundary. Each lane shape point of the plurality of lane shape points determined on the first boundary corresponds to a lane shape point of the plurality of lane shape points determined on the second boundary of the generated bounding path.

According to some example embodiments, each lane shape point of the plurality of lane shape points corresponds to a latitude, a longitude, and an altitude.

According to some example embodiments, the at least one processor is configured to transmit the data associated with the generated virtual lane to the vehicle. The at least one processor is further configured to retrieve sensor data associated with the vehicle. The at least one processor is further configured to utilize the data associated with the generated virtual lane and the retrieved sensor data for maintenance of a trajectory of the vehicle within the generated virtual lane.

According to some example embodiments, the retrieved sensor data is associated with at least one of: a camera, a Light Detection and Ranging (LiDAR) system, a radio detection and ranging (RADAR) system, or a global positioning system (GPS).

According to some example embodiments, the at least one processor is further configured to determine a trajectory of the vehicle travelling between the lane pair. The at least one processor is further configured to compare the determined trajectory of the vehicle with a predefined threshold associated with the generated virtual lane. The at least one processor is further configured to verify the determined trajectory of the vehicle to be within the generated virtual lane, based on the comparison.

According to some example embodiments, the at least one processor is further configured to detect an abnormal trajectory of the vehicle, based on a determination that the determined trajectory of the vehicle is outside the predefined threshold associated with the generated virtual lane. The at least one processor is further configured to generate a notification based on the detected abnormal trajectory of the vehicle.

According to some example embodiments, the at least one processor is further configured to update map data to prevent vehicles from changing modes at the traffic signal intersection.

Some example embodiments disclosed herein provide a method for generating a virtual lane. The method comprises determining one or more paths associated with a lane pair of the vehicle. The lane pair corresponds to an ingress lane and an egress lane associated with a road intersection. The method further comprises aggregating the determined one or more paths corresponding to the lane pair, to generate a bounding path associated with the lane pair. The method further comprises generating a virtual lane based on the generated bounding path. The generation of the virtual lane is based on determination of a plurality of lane shape points corresponding to the generated bounding path. The method further comprises storing data associated with the generated virtual lane in a map database.

According to some example embodiments, the road intersection is a traffic signal intersection.

According to some example embodiments, the method further comprises identifying the road intersection. The method further comprises retrieving signal phase and timing (SPaT) data and map data associated with the identified road intersection. The method further comprises determining the lane pair based on the retrieved SPaT data and the map data. The method further comprises retrieving historical sensor data associated with one or more vehicles passed through the determined lane pair. The method further comprises performing map matching of the retrieved historical sensor data and the determined lane pair to determine the one or more paths associated with the lane pair of the vehicle.

According to some example embodiments, the generation of the virtual lane is further based on a determination of a lane curvature associated with the generated bounding path.

According to some example embodiments, the generated bounding path further comprises a first boundary and a second boundary. Each lane shape point of the plurality of lane shape points determined on the first boundary corresponds to a lane shape point of the plurality of lane shape points determined on the second boundary of the generated bounding path.

According to some example embodiments, each lane shape point of the plurality of lane shape points corresponds to a latitude, a longitude, and an altitude.

According to some example embodiments, the method further comprises transmitting the data associated with the generated virtual lane to the vehicle. The method further comprises retrieving sensor data associated with the vehicle. The method further comprises utilizing the data associated with the generated virtual lane and the retrieved sensor data for maintenance of a trajectory of the vehicle within the generated virtual lane.

According to some example embodiments, the retrieved sensor data is associated with at least one of: a camera, a Light Detection and Ranging (LiDAR) system, a radio detection and ranging (RADAR) system, or a global positioning system (GPS).

According to some example embodiments, the method further comprises determining a trajectory of the vehicle travelling between the lane pair. The method further comprises comparing the determined trajectory of the vehicle with a predefined threshold associated with the generated virtual lane. The method further comprises verifying the determined trajectory of the vehicle to be within the generated virtual lane, based on the comparison.

Some example embodiments disclosed herein provide a computer programmable product comprising a non-transitory computer readable medium having stored thereon computer executable instruction which when executed by one or more processors, cause the one or more processors to conduct operations for generation of a virtual lane, the operations comprising determining one or more paths associated with a lane pair of the vehicle. The lane pair corresponds to an ingress lane and an egress lane associated with a traffic signal intersection. The operations further comprise aggregating the determined one or more paths corresponding to the lane pair, to generate a bounding path associated with the lane pair. The operations further comprise generating a virtual lane based on the generated bounding path. The generation of the virtual lane is based on determination of a plurality of lane shape points corresponding to the generated bounding path. The operations further comprise storing data associated with the generated virtual lane in a map database.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Having thus described example embodiments of the invention in general terms, reference will now be made to the accompanying drawings, which are not necessarily drawn to scale, and wherein:

FIG. 1 illustrates a block diagram of a network environment of a system for generation of a virtual lane, in accordance with an example embodiment:

FIG. 2A illustrates a block diagram of a system for generation of the virtual lane, in accordance with an example embodiment:

FIG. 2B illustrates an example map database record storing data, in accordance with one or more example embodiments:

FIG. 2C illustrates another example map database record storing data, in accordance with one or more example embodiments:

FIG. 2D illustrates another example map database storing data, in accordance with one or more example embodiments:

FIGS. 3A and 3B collectively illustrate an exemplary diagram depicting steps to be performed for generation of the virtual lane, in accordance with an example embodiment:

FIG. 4 illustrates an exemplary diagram depicting steps to be performed for verification of a trajectory of the vehicle, in accordance with an example embodiment:

FIG. 5 illustrates an exemplary scenario for generation of the virtual lane for vehicles passing through a traffic signal intersection, in accordance with an example embodiment; and

FIG. 6 illustrates a flow diagram of a method for generation of a virtual lane, in accordance with an example embodiment.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems, apparatuses, and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Further, the terms “a” and “an” herein do not denote a limitation of quantity, but rather denote the presence of at least one of the referenced items. Moreover, various features are described which may be exhibited by some embodiments and not by others. Similarly, various requirements are described which may be requirements for some embodiments but not for other embodiments.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein: rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ may refer to (a) hardware-only circuit implementations (for example, implementations in analog circuitry and/or digital circuitry): (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (for example, volatile or non-volatile memory device), can be differentiated from a “computer-readable transmission medium,” which refers to an electromagnetic signal.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

### Definitions

The term “route” may be used to refer to a path from a source location to a destination location on any link.

The term “autonomous vehicle” may refer to any vehicle having autonomous driving capabilities at least in some conditions. An autonomous vehicle, as used throughout this disclosure, may refer to a vehicle having autonomous driving capabilities at least in some conditions. The autonomous vehicle may also be known as a driverless car, robot car, self-driving car, or autonomous car. For example, the vehicle may have zero passengers or passengers that do not manually drive the vehicle, but the vehicle drives and maneuvers automatically. There can also be semi-autonomous vehicles.

The term “machine learning model” may be used to refer to a computational or statistical or mathematical model that is based in part or on the whole on artificial intelligence and deep learning techniques. The “machine learning model” is trained over a set of data and using an algorithm that it may use to learn from the dataset.

The term “deep learning” is a type of machine learning that utilizes both structured and unstructured data for training.

### End of Definitions

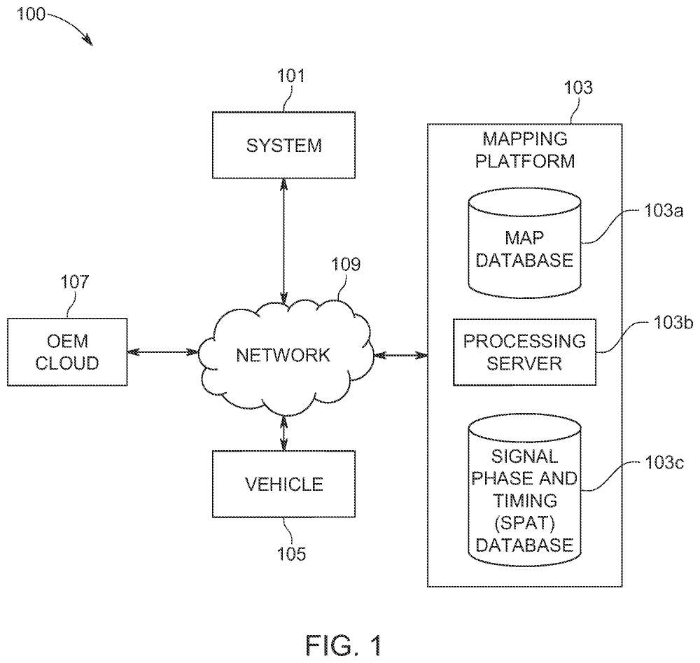

Embodiments of the present disclosure may provide a system, a method, and a computer program product for generation of a virtual lane. Often times, vehicles, such as autonomous vehicles (AVs) passing through a traffic signal intersection are unable to identify a lane marking associated with a lane pair of the traffic signal intersection. The AVs may follow an undesirable path while passing through the lane pair, due to the lack of identification of the lane marking that may lead to accidents. Moreover, the AVs may require to be switched to a driving mode from an autonomous mode, at the traffic signal intersection for maintenance of safety of the AV and nearby vehicles. Thus, there is a need for solution for the AVs to follow a desirable path to eliminate risk of accidents at the traffic signal intersection. The system, the method, and the computer program product facilitating the generation of a virtual lane for safe travel of the AVs in such an improved manner are described with reference to FIG. 1 to FIG. 6 as detailed below:

FIG. 1 illustrates a block diagram of a network environment 100 of a system 101 for generation of a virtual lane, in accordance with an example embodiment. The system 101 may be communicatively coupled to a mapping platform 103, a vehicle 105 and an OEM (Original Equipment Manufacturer) cloud 107 via a network 109. The components described in the network environment 100 may be further broken down into more than one component such as one or more sensors or applications in the system 101 and/or combined together in any suitable arrangement. Further, it is possible that one or more components may be rearranged, changed, added, and/or removed.

In an example embodiment, the system 101 may be embodied in one or more of several ways as per the required implementation. For example, the system 101 may be embodied as a cloud-based service or a cloud-based platform. In each of such embodiments, the system 101 may be communicatively coupled to the components shown in FIG. 1 to carry out the desired operations and wherever required modifications may be possible within the scope of the present disclosure. The system 101 may be implemented in a vehicle, such as the vehicle 105, where the vehicle may be an autonomous vehicle, a semi-autonomous vehicle, or a manually driven vehicle. Further, in one embodiment, the system 101 may be a standalone unit configured to validate sensor data associated with sensors in a hazard warning system of a vehicle. Alternatively, the system 101 may be coupled with an external device such as the autonomous vehicle. In an embodiment, the system 101 may also be referred to as a user equipment (UE). In some example embodiments, the system 101 may be any user accessible device such as a mobile phone, a smartphone, a portable computer, and the like that are portable in themselves or as a part of another portable/mobile object such as a vehicle. The system 101 may comprise a processor, a memory, and a communication interface. The processor, the memory and the communication interface may be communicatively coupled to each other. In some example embodiments, the system 101 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to a user based on a prediction of a vehicle's accident. In such example embodiments, the system 101 may comprise a processing means such as a central processing unit (CPU), storage means such as on-board read only memory (ROM) and random access memory (RAM), acoustic sensors such as a microphone array, position sensors such as a global positioning system (GPS) sensor, gyroscope, a light imaging and detection (LiDAR) sensor, a proximity sensor, motion sensors such as accelerometer, a display enabled user interface such as a touch screen display, and other components as may be required for specific functionalities of system 101. Additional, different, or fewer components may be provided. For example, the system 101 may be configured to execute and run mobile applications such as a messaging application, a browser application, a navigation application, and the like. For example, system 101 may be a dedicated vehicle (or a part thereof) for gathering data related to accident of other vehicles in a database map 103a. For example, the system 101 may be a consumer vehicle (or a part thereof). In some example embodiments, the system 101 may serve the dual purpose of a data gatherer and a beneficiary device. The system 101 may be configured to capture sensor data associated with the vehicle or a road which the system 101 may be traversing. In some scenarios, the system 101 may be configured to receive the sensor data from one or more sensors. The sensor data may for example be audio signals in and outside the vehicle, image data of road objects, road signs, hazard data, or the surroundings (for example buildings). The sensor data may refer to sensor data collected from a sensor unit in the system 101. In accordance with an embodiment, the sensor data may refer to the data captured by the vehicle 105 using sensors.

In some other embodiments, the system 101 may be an OEM (Original Equipment Manufacturer) cloud, such as the OEM cloud 107. The OEM cloud 107 may be configured to anonymize any data received from the system 101, such as the vehicle 105, before using the data for further processing, such as before sending the data to the mapping platform 103. In some embodiments, anonymization of data may be done by the mapping platform 103.

The mapping platform 103 may comprise a map database 103a for storing map data, a processing server 103b and a signal phase and timing (SPaT) database 103c. The map database 103a may include data associated with vehicle's accidents on road/s, one or more of a road sign, or speed signs, or road objects on the link or path. Further, the map database 103a may store accident data, node data, road segment data, link data, point of interest (POI) data, link identification information, heading value records, or the like. Also, the map database 103a further includes speed limit data of each lane, cartographic data, routing data, and/or maneuvering data. Additionally, the map database 103a may be updated dynamically to cumulate real time traffic conditions based on prediction of vehicle's accident. The real-time traffic conditions may be collected by analyzing the location transmitted to the mapping platform 103 by a large number of road users travelling by vehicles through the respective user devices of the road users. In one example, by calculating the speed of the road users along a length of road, the mapping platform 103 may generate a live traffic map, which is stored in the map database 103a in the form of real time traffic conditions based on prediction of vehicle's accident. In one embodiment, the map database 103a may further store historical traffic data that includes travel times, accident prone areas, areas with least and maximum accidents, average speeds and probe counts on each road or area at any given time of the day and any day of the year. According to some example embodiments, the road segment data records may be links or segments representing roads, streets, or paths, as may be used in calculating a route or recorded route information for determination of one or more personalized routes to avoid a zone/route with the predicted accident. The node data may be end points corresponding to the respective links or segments of road segment data. The road link data and the node data may represent a road network used by vehicles such as cars, trucks, buses, motorcycles, and/or other entities. Optionally, the map database 103a may contain path segment and node data records, such as shape points or other data that may represent pedestrian paths, links, or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The map database 103a may also store data about the POIs and their respective locations in the POI records. The map database 103a may additionally store data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database 103a may include event data (e.g., traffic incidents, construction activities, scheduled events, unscheduled events, vehicle accidents, diversions etc.) associated with the POI data records or other records of the map database 103a associated with the mapping platform 103. Optionally, the map database 103a may contain path segment and node data records or other data that may represent pedestrian paths or areas in addition to or instead of the autonomous vehicle road record data. In an embodiment, the map database 103a may be a source-available document-oriented database.

In some embodiments, the map database 103a may be a master map database stored in a format that facilitates updating, maintenance and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services in an event of a predicted vehicle's accident, such as route calculation, route guidance, map display, speed calculation, distance and travel time functions, and other functions, by a navigation device, such as by the system 101 or the vehicle 105. The navigation-related functions may correspond to vehicle navigation, pedestrian navigation, or other types of navigation to avoid a zone where the vehicle accident has been predicted by the system 101. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the map database 103a may be a master geographic database, but in alternate embodiments, the map database 103a may be embodied as a client-side map database and may represent a compiled navigation database that may be used in the system 101 to provide navigation and/or map-related functions in an event of a predicted vehicle's accident. For example, the map database 103a may be used with the system 101 to provide an end user with navigation features. In such a case, the map database 103a may be downloaded or stored locally (cached) on the system 101.

The processing server 103b may comprise processing means, and communication means. For example, the processing means may comprise one or more processors configured to process requests received from the system 101. The processing means may fetch map data from the map database 103a and transmit the same to the system 101 via the OEM cloud 107 in a format suitable for use by the system 101. In one or more example embodiments, the mapping platform 103 may periodically communicate with the system 101 via the processing server 103b to update a local cache of the map data stored on the system 101. Accordingly, in some example embodiments, the map data may also be stored on the system 101 and may be updated based on periodic communication with the mapping platform 103. In some embodiments, the map data may also be stored on a user equipment associated with the vehicle 105 and may be updated based on periodic communication with the mapping platform 103.

The SPaT database 103c is associated with a traffic signal system located at the traffic signal intersection. The SPaT database 103c may store data in SPaT format that may be utilized to describe a current state of the traffic signal system and traffic signal phases corresponding to specific lanes in the traffic signal intersection. The SPaT data may be delivered to the vehicle 105 or navigation system through a dedicated short-range communication (DSRC) network or cellular network as the vehicle 105 is approaching to the traffic signal intersection or is within a certain distance of the traffic signal intersection. In some embodiments, the SPaT database 103c may be external to the mapping platform 103, but communicatively coupled to the mapping platform 103 in one or more ways through a communication channel. For example, the communication channel may comprise the network 109.

The network 109 may be wired, wireless, or any combination of wired and wireless communication networks, such as cellular, Wi-Fi, internet, local area networks, or the like. In one embodiment, the network 109 may include one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks (for e.g. LTE-Advanced Pro), 5G New Radio networks, ITU-IMT 2020 networks, code division multiple access (CDMA), wideband code division multiple access (WCDMA), wireless fidelity (Wi-Fi), wireless LAN (WLAN), Bluetooth, Internet Protocol (IP) data casting, satellite, mobile ad-hoc network (MANET), and the like, or any combination thereof. In an example, the mapping platform 103 may be integrated into a single platform to provide a suite of mapping and navigation related applications for OEM devices, such as the user devices and the system 101. The system 101 may be configured to communicate with the mapping platform 103 over the network 109. Thus, the mapping platform 103 may enable provision of cloud-based services for the system 101, such as, storing the lane marking observations in the OEM cloud 107 in batches or in real-time.

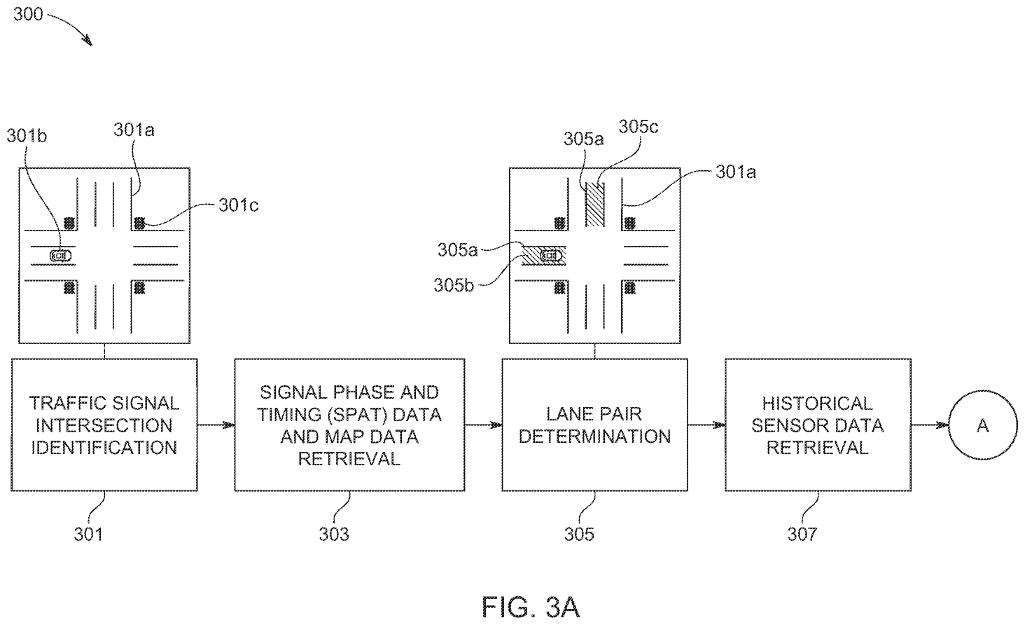

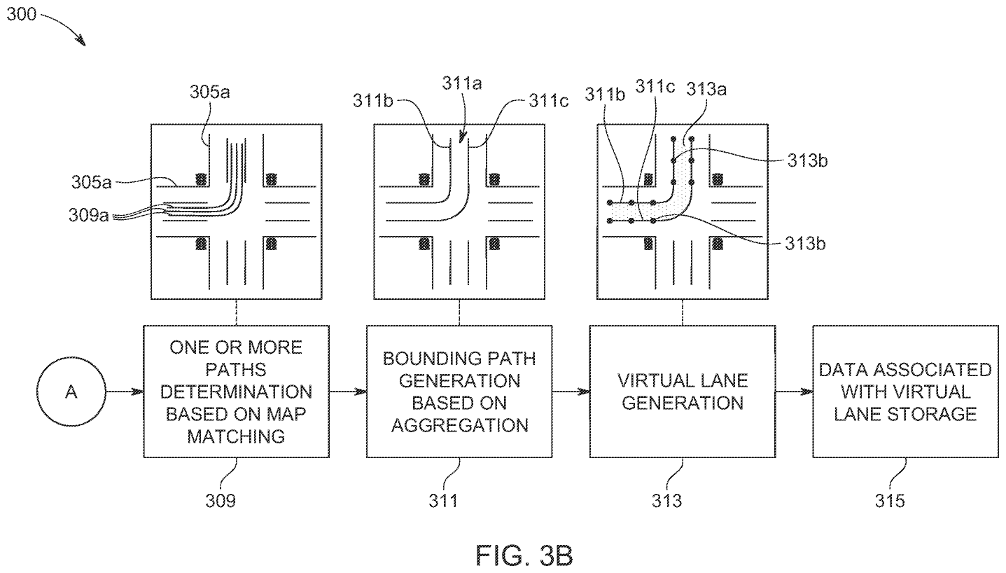

In operation, the vehicle 105 may be travelling on a road. The system 101 may identify a road intersection, such as the traffic signal intersection associated with the vehicle 105. Examples of a type of the road intersection may include, but may not be limited to, a traffic signal intersection, a non-signalized intersection, a non-Manhattan style intersection (i.e. an intersection with a non 90 degree angle), an n-way (such as a three way) intersection, a round-about, a cloverleaf interchange intersection, a diamond interchange intersection, or a trumpet interchange intersection. Details of the identification of the traffic signal intersection are further provided, for example, in FIG. 3A.

The system 101 may further determine one or more paths associated with a lane pair of the vehicle 105. The lane pair may correspond to an ingress lane and an egress lane associated with the traffic signal intersection. Furthermore, the system 101 may aggregate the determined one or more paths corresponding to the lane pair, to generate a bounding path associated with the lane pair. In an embodiment, the generated bounding path further includes a first boundary and a second boundary. Details of the determination of the one or more paths and generation of the bounding path are further provided, for example, in FIG. 3B.

Based on the generated bounding path, the system 101 may further generate a virtual lane. The generation of the virtual lane is based on determination of a plurality of lane shape points corresponding to the generated bounding path. In an embodiment, each lane shape point of the plurality of lane shape points corresponds to a latitude, a longitude, and an altitude. The data associated with the generated virtual lane may be further stored in the map database 103a. Details of the generation of the virtual lane are further provided, for example, in FIG. 3B.

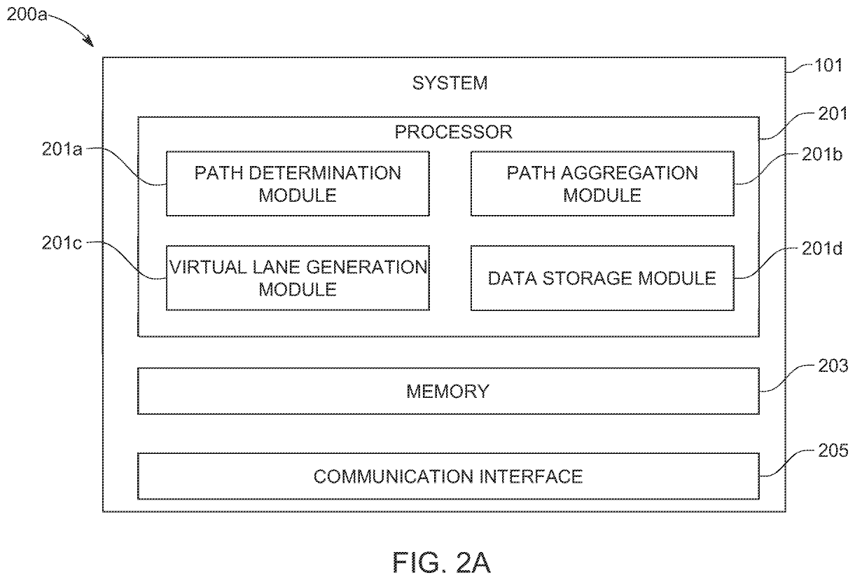

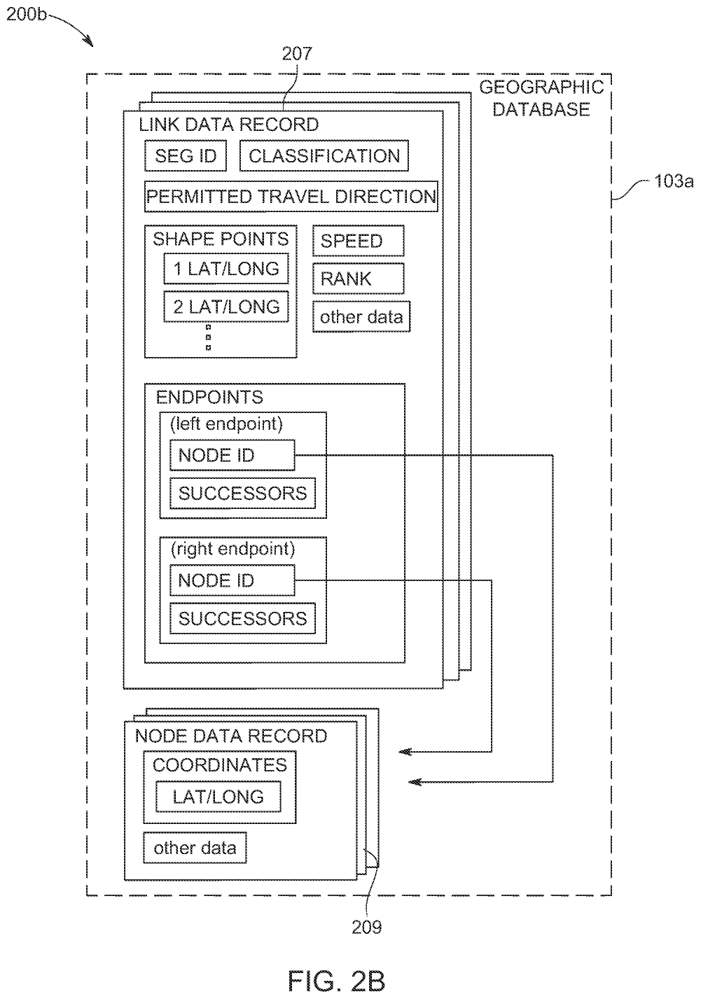

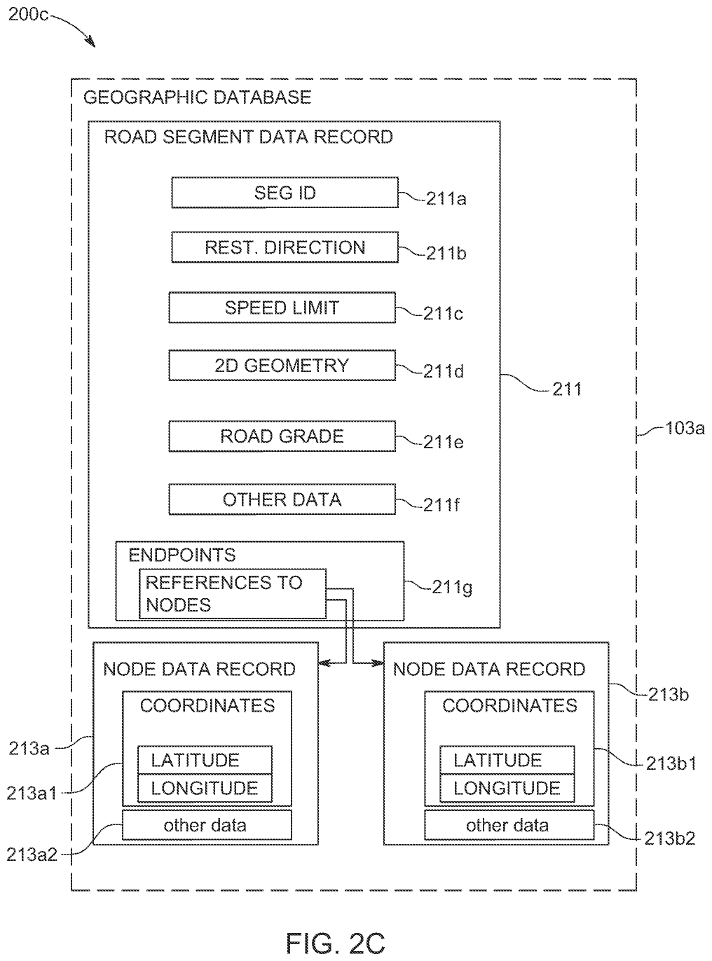

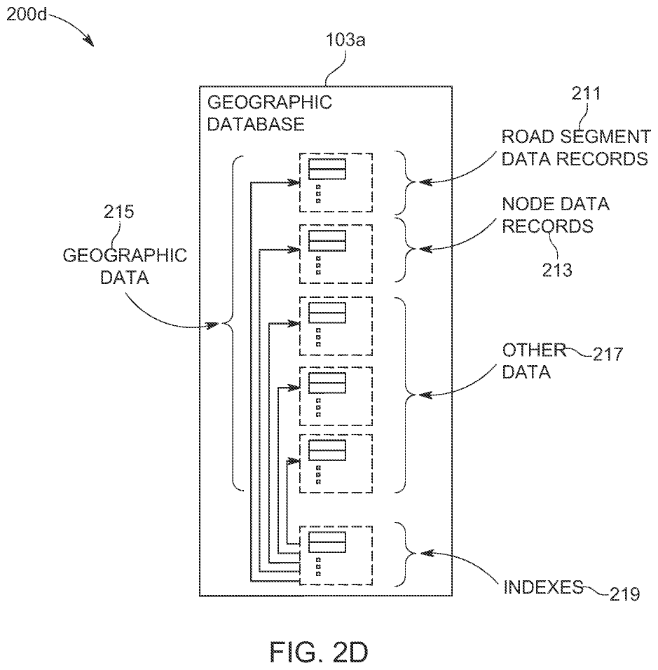

FIG. 2A illustrates a block diagram 200a of the system 101 for generation of the virtual lane, in accordance with an example embodiment. The system 101 may include a processing means such as at least one processor 201 (hereinafter, also referred to as “processor 201”), storage means such as at least one memory 203 (hereinafter, also referred to as “memory 203”), and a communication means such as at least one communication interface 205 (hereinafter, also referred to as “communication interface 205”). The processor 201 may further include one or more processing modules, such as a path determination module 201a, a path aggregation module 201b, a virtual lane generation module 201c and a data storage module 201d. The processor 201 may retrieve computer program code instructions that may be stored in the memory 203 for execution of the computer program code instructions.

The processor 201 may be embodied in a number of different ways. For example, the processor 201 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 201 may include one or more processing cores configured to perform independently. A multi-core processor may enable multiprocessing within a single physical package. Additionally, or alternatively, the processor 201 may include one or more processors configured in tandem via the bus to enable independent execution of instructions, pipelining and/or multithreading.

In some embodiments, the processor 201 may be configured to provide Internet-of-Things (IoT) related capabilities to users of the system 101, where the users may be a traveler, a rider, a pedestrian, and the like. In some embodiments, the users may be or correspond to an autonomous or a semi-autonomous vehicle. The IoT related capabilities may in turn be used to provide smart navigation solutions and hazard warnings by providing real time updates to the users to take pro-active decision on turn-maneuvers, lane changes, overtaking, merging and the like, big data analysis, and sensor-based data collection by using the cloud-based mapping system for providing navigation recommendation services to the users. The system 101 may be accessed using the communication interface 205. The communication interface 205 may provide an interface for accessing various features and data stored in the system 101.

Additionally, or alternatively, the processor 201 may include one or more processors capable of processing large volumes of workloads and operations to provide support for big data analysis. In an example embodiment, the processor 201 may be in communication with the memory 203 via a bus for passing information among components coupled to the system 101.

The path determination module 201a may be configured to determine one or more paths associated with a lane pair of the vehicle 105. The lane pair may correspond to an ingress lane and an egress lane associated with the road intersection, such as the traffic signal intersection or an intersection without traffic signals. In an embodiment, the one or more paths may be determined based on historical sensor data associated with one or more vehicles that passed through the lane pair. Details of the determination of the one or more paths associated with a lane pair of the vehicle 105 are further described, for example, in FIGS. 3A and 3B.

The path aggregation module 201b may be configured to aggregate the determined one or more paths corresponding to the lane pair, to generate a bounding path associated with the lane pair. The one or more paths followed by the one or more vehicles may be aggregated to determine the bounding path. The bounding path may include a first boundary and a second boundary as extremities. Details of the aggregation of the determined one or more paths are further described, for example, in FIG. 3B.

The virtual lane generation module 201c may be configured to generate a virtual lane based on the generated bounding path. The generation of the virtual lane may be based on determination of a plurality of lane shape points corresponding to the generated bounding path. In an embodiment, the generation of the virtual lane may be further based on a determination of a lane curvature associated with the generated bounding path. Details of the generation of the virtual lane are further described, for example, in FIG. 3B.

The data storage module 201d may be configured to store data associated with the generated virtual lane in the map database 103a. The data associated with the generated virtual lane may be utilized for maintenance of a trajectory of the vehicle 105 within the generated virtual lane. Details of the storage of data associated with the generated virtual lane are further described, for example, in FIG. 3B.

The memory 203 may be non-transitory and may include, for example, one or more volatile and/or non-volatile memories. In other words, for example, the memory 203 may be an electronic storage device (for example, a computer readable storage medium) comprising gates configured to store data (for example, bits) that may be retrievable by a machine (for example, a computing device like the processor 201). The memory 203 may be configured to store information, data, content, applications, instructions, or the like, for enabling the apparatus to carry out various functions in accordance with an example embodiment of the present invention. For example, the memory 203 may be configured to buffer input data for processing by the processor 201. As exemplarily illustrated in FIG. 2A, the memory 203 may be configured to store instructions for execution by the processor 201. As such, whether configured by hardware or software methods, or by a combination thereof, the processor 201 may represent an entity (for example, physically embodied in circuitry) capable of performing operations according to an embodiment of the present invention while configured accordingly. Thus, for example, when the processor 201 is embodied as an ASIC. FPGA or the like, the processor 201 may be specifically configured hardware for conducting the operations described herein. Alternatively, as another example, when the processor 201 is embodied as an executor of software instructions, the instructions may specifically configure the processor 201 to perform the algorithms and/or operations described herein when the instructions are executed. However, in some cases, the processor 201 may be a processor specific device (for example, a mobile terminal or a fixed computing device) configured to employ an embodiment of the present invention by further configuration of the processor 201 by instructions for performing the algorithms and/or operations described herein. The processor 201 may include, among other things, a clock, an arithmetic logic unit (ALU) and logic gates configured to support operation of the processor 201.

The communication interface 205 may comprise input interface and output interface for supporting communications to and from the system 101 or any other component with which the system 101 may communicate. The communication interface 205 may be any means such as a device or circuitry embodied in either hardware or a combination of hardware and software that is configured to receive and/or transmit data to/from a communications device in communication with the system 101. In this regard, the communication interface 205 may include, for example, an antenna (or multiple antennae) and supporting hardware and/or software for enabling communications with a wireless communication network. Additionally, or alternatively, the communication interface 205 may include the circuitry for interacting with the antenna(s) to cause transmission of signals via the antenna(s) or to handle receipt of signals received via the antenna(s). In some environments, the communication interface 205 may alternatively or additionally support wired communication. As such, for example, the communication interface 205 may include a communication modem and/or other hardware and/or software for supporting communication via cable, digital subscriber line (DSL), universal serial bus (USB) or other mechanisms. In some embodiments, the communication interface 205 may enable communication with a cloud-based network to enable deep learning, such as using a convolutional neural network mode.

FIG. 2B shows format of the map data 200b stored in the map database 103a according to one or more example embodiments. FIG. 2B shows a link data record 207 that may be used to store data about one or more of the feature lines. This link data record 207 has information (such as “attributes”, “fields”, etc.) associated with it that allows identification of the nodes associated with the link and/or the geographic positions (e.g., the latitude and longitude coordinates and/or altitude or elevation) of the two nodes. In addition, the link data record 207 may have information (e.g., more “attributes”, “fields”, etc.) associated with it that specify the permitted speed of travel on the portion of the road represented by the link record, the direction of travel permitted on the road portion represented by the link record, what, if any, turn restrictions exist at each of the nodes which correspond to intersections at the ends of the road portion represented by the link record, the street address ranges of the roadway portion represented by the link record, the name of the road, and so on. The various attributes associated with a link may be included in a single data record or are included in more than one type of record which are referenced to each other.

Each link data record that represents another-than-straight road segment may include shape point data. A shape point is a location along a link between its endpoints. To represent the shape of other-than-straight roads, the mapping platform 103 and its associated map database developer selects one or more shape points along the other-than-straight road portion. Shape point data included in the link data record 207 indicate the position, (e.g., latitude, longitude, and optionally, altitude or elevation) of the selected shape points along the represented link.

Additionally, in the compiled geographic database, such as a copy of the map database 103a, there may also be a node data record 209 for each node. The node data record 209 may have associated with it information (such as “attributes”, “fields”, etc.) that allows identification of the link(s) that connect to it and/or its geographic position (e.g., its latitude, longitude, and optionally altitude or elevation).

In some embodiments, compiled geographic databases are organized to facilitate the performance of various navigation-related functions. One way to facilitate performance of navigation-related functions is to provide separate collections or subsets of the geographic data for use by specific navigation-related functions. Each such separate collection includes the data and attributes needed for performing the particular associated function but excludes data and attributes that are not needed for performing the function. Thus, the map data may be alternately stored in a format suitable for performing types of navigation functions, and further may be provided on-demand, depending on the type of navigation function.

FIG. 2C shows another format of the map data 200c stored in the map database 103a according to one or more example embodiments. In the FIG. 2C, the map data 200c is stored by specifying a road segment data record 211. The road segment data record 211 is configured to represent data that represents a road network. In FIG. 2C, the map database 103a contains at least one road segment data record 211 (also referred to as “entity” or “entry.”) for each road segment in a geographic region.

The map database 103a that represents the geographic region of FIG. 2A also includes a database record 213 (a node data record 213a and a node data record 213b) (or “entity” or “entry”) for each node associated with the at least one road segment shown by the road segment data record 211. (The terms “nodes” and “segments” represent only one terminology for describing these physical geographic features and other terminology for describing these features is intended to be encompassed within the scope of these concepts). Each of the node data records 213a and 213b may have associated information (such as “attributes”, “fields”, etc.) that allows identification of the road segment(s) that connect to it and/or its geographic position (e.g., its latitude and longitude coordinates).

FIG. 2C also shows some of the components of the road segment data record 211 contained in the map database 103a. The road segment data record 211 includes a segment ID 211a by which the data record can be identified in the map database 103a. Each road segment data record 211 has associated with it information (such as “attributes”, “fields”, etc.) that describes features of the represented road segment. The road segment data record 211 may include data 211b that indicate the restrictions, if any, on the direction of vehicular travel permitted on the represented road segment. The road segment data record 211 includes data 211c that indicate a static speed limit or speed category (i.e., a range indicating maximum permitted vehicular speed of travel) on the represented road segment. The static speed limit is a term used for speed limits with a permanent character, even if they are variable in a pre-determined way, such as dependent on the time of the day or weather. The static speed limit is the sign posted explicit speed limit for the road segment, or the non-sign posted implicit general speed limit based on legislation.

The road segment data record 211 may also include data 211d indicating the two-dimensional (“2D”) geometry or shape of the road segment. If a road segment is straight, its shape can be represented by identifying its endpoints or nodes. However, if a road segment is other-than-straight, additional information is required to indicate the shape of the road. One way to represent the shape of an other-than-straight road segment is to use shape points. Shape points are points through which a road segment passes between its end points. By providing the latitude and longitude coordinates of one or more shape points, the shape of an other-than-straight road segment can be represented. Another way of representing other-than-straight road segment is with mathematical expressions, such as polynomial splines.

The road segment data record 211 also includes road grade data 211e that indicate the grade or slope of the road segment. In one embodiment, the road grade data 211e include road grade change points and a corresponding percentage of grade change. Additionally, the road grade data 211e may include the corresponding percentage of grade change for both directions of a bi-directional road segment. The location of the road grade change point is represented as a position along the road segment, such as thirty feet from the end or node of the road segment. For example, the road segment may have an initial road grade associated with its beginning node. The road grade change point indicates the position on the road segment wherein the road grade or slope changes, and percentage of grade change indicates a percentage increase or decrease of the grade or slope. Each road segment may have several grade change points depending on the geometry of the road segment. In another embodiment, the road grade data 211e includes the road grade change points and an actual road grade value for the portion of the road segment after the road grade change point until the next road grade change point or end node. In a further embodiment, the road grade data 211e includes elevation data at the road grade change points and nodes. In an alternative embodiment, the road grade data 211e is an elevation model which may be used to determine the slope of the road segment.

The road segment data record 211 also includes data 211g providing the geographic coordinates (e.g., the latitude and longitude) of the end points of the represented road segment. In one embodiment, the data 211g are references to the node data records 213 that represent the nodes corresponding to the end points of the represented road segment.

The road segment data record 211 may also include or be associated with other data 211f that refer to various other attributes of the represented road segment. The various attributes associated with a road segment may be included in a single road segment record or may be included in more than one type of record which cross-reference each other. For example, the road segment data record 211 may include data identifying the name or names by which the represented road segment is known, the street address ranges along the represented road segment, and so on.

FIG. 2C also shows some of the components of the node data record 213 contained in the map database 103a. Each of the node data records 213 may have associated information (such as “attributes”, “fields”, etc.) that allows identification of the road segment(s) that connect to it and/or it's geographic position (e.g., its latitude and longitude coordinates). For the embodiment shown in FIG. 2C, the node data records 213a and 213b include the latitude and longitude coordinates 213a1 and 213b1 for their nodes. The node data records 213a and 213b may also include other data 213a2 and 213b2 that refer to various other attributes of the nodes.

Thus, the overall data stored in the map database 103a may be organized in the form of different layers for greater detail, clarity, and precision. Specifically, in the case of high-definition maps, the map data may be organized, stored, sorted, and accessed in the form of three or more layers. These layers may include road level layer, lane level layer and localization layer. The data stored in the map database 103a in the formats shown in FIG. 2B and FIG. 2C may be combined in a suitable manner to provide these three or more layers of information. In some embodiments, there may be lesser or fewer number of layers of data also possible, without deviating from the scope of the present disclosure.

FIG. 2D illustrates a block diagram 200d of the map database 103a storing map data or geographic data 215 in the form of road segments/links, nodes, and one or more associated attributes as discussed above. Furthermore, attributes may refer to features or data layers associated with the link-node database, such as an HD lane data layer.

In addition, the map data may also include other kinds of data 217. The other kinds of data 217 may represent other kinds of geographic features or anything else. The other kinds of data may include point of interest data. For example, the point of interest data may include point of interest records comprising a type (e.g., the type of point of interest, such as restaurant, ATM, etc.), location of the point of interest, a phone number, hours of operation, etc. The map database 103a also includes indexes 219. The indexes 219 may include various types of indexes that relate the different types of data to each other or that relate to other aspects of the data contained in the geographic database 103a.

The data stored in the map database 103a in the various formats discussed above may help in provide precise data for high-definition mapping applications, autonomous vehicle navigation and guidance, cruise control using ADAS, direction control using accurate vehicle maneuvering and other such services. In some embodiments, the system 101 accesses the map database 103a storing data in the form of various layers and formats depicted in FIG. 2B-FIG. 2D.

FIG. 3A and FIG. 3B collectively illustrates an exemplary diagram 300 depicting steps to be performed for generation of the virtual lane, in accordance with an example embodiment. FIG. 3A and FIG. 3B are described in conjunction with elements from FIG. 1. FIG. 2A, FIG. 2B, FIG. 2C and FIG. 2D. FIG. 3A and FIG. 3B include steps 301 to 315. It will be understood that one or more steps of the exemplary diagram 300, and combinations of steps in the exemplary diagram 300, may be implemented by special purpose hardware-based computer systems which perform the specified functions, or combinations of special purpose hardware and computer instructions. The steps illustrated by the exemplary diagram 300 is used for generation of the virtual lane. Fewer, more, or different steps may be provided.

At step 301, a traffic signal intersection 301a may be identified. In some embodiments, the processor 201 may be configured to identify the traffic signal intersection 301a. The traffic signal intersection 301a may be associated with a vehicle 301b. For example, the vehicle 301b may be travelling towards the traffic signal intersection 301a. In another example, the vehicle 301b may be at the traffic signal intersection 301a.

The traffic signal intersection 301a may include a plurality of lanes. The plurality of lanes may be connected via the traffic signal intersection 301a. The plurality of lanes may include lane pairs. Each lane pair may correspond to an ingress lane and an egress lane associated with a traffic signal intersection 301a. The ingress lane (or an incoming lane) may be a lane in which the vehicle 301b may be present. The egress lane may be any lane that the vehicle 301b may enter after crossing the traffic signal intersection 301a. For example, the vehicle 301b may cross the traffic signal intersection 301a to enter an opposite lane of the plurality of lanes. In another example, the vehicle 301b may cross the traffic signal intersection 301a to enter a lane that may be towards a left side of the vehicle 301b. Similarly, the vehicle 301b in the ingress lane may enter any egress lane of the plurality of lanes. Moreover, the traffic signal intersection 301a may include one or more traffic signal systems, such as a traffic light signal 301c installed near the plurality of lanes to facilitate secure movement of the vehicles, such as the vehicle 301b between the plurality of lanes.

The processor 201 may be configured to identify the traffic signal intersection 301a based on a determination of a location of the vehicle 301b. For example, a GPS location of the vehicle 301b may be utilized to identify the traffic signal intersection 301a. The GPS location of the vehicle 301b may be tracked to identify a real-time location of the vehicle 301b. In an example, the traffic signal intersection 301a may be identified when the vehicle 301b may be present in the ingress lane of the plurality of lanes. The processor 201 may retrieve information about the plurality of lanes at the traffic signal intersection 301a, based on the identified traffic signal intersection 301a.

At step 303, SPaT data and map data associated with the identified traffic signal intersection 301a may be retrieved. In some embodiments, the processor 201 may be configured to retrieve the SPaT data and the map data associated with the identified traffic signal intersection 301a. The SPaT data may be associated with the traffic signal systems, such as the traffic light signal 301c. The SPaT data may be utilized for describing the current state of the traffic light signal 301c for the traffic signal intersection 301a and the traffic signal phases corresponding to specific lanes in the traffic signal intersection 301a. The SPaT data may be delivered to the vehicle 301b or the navigation system through the DSRC or the cellular network as the vehicle 301b may be approaching to the traffic signal intersection 301a or may be within a certain distance of the traffic signal intersection 301a. The SPaT data may be utilized by the AVs, such as the vehicle 301b while driving through the traffic signal intersection 301a.

The map data may be utilized to describe a static physical geometry layout of one or more traffic signal intersections, such as the traffic signal intersection 301a. The map data may be further utilized to convey other types of geographic road information to the vehicle 301b. The map data may be used with the SPaT data to describe the traffic signal intersection 301a and the current control state of the traffic signal intersection 301a in one or more DSRC based messages. Moreover, the map data may be pre-cached and may be stored in the vehicle 301b or as a part of the navigation system. The map data may further be transmitted to the vehicle 301b as the vehicle 301b approaches the traffic signal intersection 301a in real-time.

The map data may include connection information that may link at least one ingress lane or the egress lane at the traffic signal intersection 301a to one or more ingress lane or the egress lane of the plurality of lanes at the traffic signal intersection 301a. The map data may further include maneuver information that may indicate a desired movement or a trajectory of the vehicle 301b through the traffic signal intersection 301a that may include the at least one ingress lane or the egress lane. The map data may further include the signal phase of the traffic light signal 301c at the traffic signal intersection 301a corresponding to the trajectory of the vehicle 301b.

The SPaT data and the map data may be categorized by tiles. Multiple layers of the SPaT data and the map data may be defined. A first layer may define a stop line geometry that may determine a lane specific position of stopping line for each traffic available lane in at the traffic signal intersection 301a. A second layer define a geometry for each lane in at the traffic signal intersection 301a. A third layer may describe the traffic signal intersection 301a in a simplified manner. The third layer may be created by processing a detailed geometry layer in a manner that may provide an efficient description by use of small number of data bytes. The third layer may be indexed with an identifier associated with the traffic signal intersection 301a. A fourth layer may include metadata associated with the traffic light system that may include additional data to help optimize the efficiency of the third layer. For example, the fourth layer may include data such as a distance to nearby traffic signal intersections or sight line visibility to the traffic signal intersection around a curve of the traffic signal intersection.

The SPaT data and the map data may be utilized in real-time to support autonomous driving applications associated with the traffic signal intersection 301a. The AVs may receive the SPaT data of the traffic light signal 301c located at the traffic signal intersection 301a along with the map data for performing one or more navigation functions. Such SPaT data and the map data associated with the identified traffic signal intersection 301a may be retrieved by the processor 201. For example, the SPaT data may be retrieved from the SPaT database 103c, and the map data may be retrieved from the map database 103a the processor 201.

At step 305, a lane pair 305a may be determined based on the retrieved SPaT data and the map data. In some embodiments, the processor 201 may be configured to determine the lane pair 305a based on the retrieved SPaT data and the map data. In an embodiment, the lane pair 305a may be determined based on the map data in case the road intersection is the non-signalized intersection. The lane pair 305a may include an ingress lane 305b and an egress lane 305c. The vehicle 301b may be present in the ingress lane 305b. The vehicle 301b may require entering the egress lane 305c. Thus, the lane pair 305a at the traffic signal intersection 301a may be determined to determine the lanes that may be used by the vehicle 301b to travel at the traffic signal intersection 301a.

The map data may include the connection information from the ingress lane 305b to the egress lane 305c that may be utilized for the determination of the lane pair 305a. The SPaT data of the one or more traffic light signals, such as the traffic light signal 301c may further be utilized for determining the egress lane 305c of the lane pair 305a. Thus, the processor 201 may determine the lane pair 305a based on the information about the ingress lane 305b in which the vehicle 301b may be present and the information about the egress lane 305c that may be retrieved from the SPaT data and the map data.

At step 307, the historical sensor data associated with one or more vehicles passed through the determined lane pair 305a may be retrieved. In some embodiments, the processor 201 may be configured to retrieve the historical sensor data associated with one or more vehicles passed through the determined lane pair 305a. In an exemplary scenario, the one or more vehicles may have passed through the determined lane pair 305a. For example, the lane pair 305a may be utilized by the one or more vehicles previously to cross the traffic signal intersection 301a.

In one or more embodiments, the historical sensor data may be associated with one or more GPS sensors of the one or more vehicles. For example, the one or more GPS sensors GPS sensor may record a live location of the one or more vehicles in real-time. The processor 201 may retrieve the historical sensor data, such as the live location from the one or more GPS sensors of the one or more vehicles. In an embodiment, the historical sensor data may be associated with trajectories of the one or more vehicles while travelling from the ingress lane 305b to the egress lane 305c of the lane pair 305a that may determined by the recorded live locations of the one or more vehicles.

In an embodiment, the historical sensor data associated with the one or more vehicles may be retrieved over a period of time, such as hours, a day, a week, a month, and so forth. For example, the historical sensor data associated with the one or more vehicles that may have utilized the lane pair 305a in two hours (such as between 4 PM and 6 PM) may be retrieved.

At 309, one or more paths 309a associated with the lane pair 305a of the vehicle 301b may be determined. In some embodiments, the processor 201 may be configured to perform map matching of the retrieved historical sensor data and the determined lane pair 305a to determine the one or more paths 309a associated with the lane pair 305a of the vehicle 301b. For example, the one or more paths 309a may include a first path followed by a first vehicle travelling in the lane pair 305a, a second path followed by a second vehicle travelling in the lane pair 305a, a third path followed by a third vehicle of the one or more vehicles travelling in the lane pair 305a of the vehicle 301b, and so forth.

The map matching of the retrieved historical sensor data may be performed on a lane level of the determined lane pair 305a to determine the one or more paths 309a. The map matching may be used to determine the one or more paths 309a (such as the trajectories) of the one or more vehicles travelling in the lane pair 305a by use of the location of the one or more vehicles while passing the lane pair 305a and matching the location with the geographical coordinates on the map corresponding to the traffic signal intersection 301a.

At 311, the determined one or more paths 309a corresponding to the lane pair 305a may be aggregated, to generate a bounding path 311a associated with the lane pair 305a. The processor 201 may be configured to aggregate the determined one or more paths 309a corresponding to the lane pair 305a to generate the bounding path 311a associated with the lane pair 305a. The determined one or more paths 309a may be aggregated to determine extremities within which the vehicle 301b may travel for a safe travel between the lane pair 305a.

In some embodiments, the generated bounding path 311a may further include a first boundary 311b and a second boundary 311c. The first boundary 311b and the second boundary 311c may define the extremities within which the vehicle 301b may travel for the safe travel between the lane pair 305a. For example, the processor 201 may compute extreme paths of the determined one or more paths 309a to generate the bounding path 311a.

At 313, a virtual lane 313a may be generated based on the generated bounding path 311a. The processor 201 may be configured to generate the virtual lane 313a based on the generated bounding path 311a. The generation of the virtual lane 313a may be based on determination of a plurality of lane shape points 313b corresponding to the generated bounding path 311a. The plurality of lane shape points 313b may be determined at the first boundary 311b and the second boundary 311c of the bounding path 311a. The plurality of lane shape points 313b may be, for example, nodes determined at specific distances on the first boundary 311b and the second boundary 311c of the generated bounding path 311a.

In some embodiments, each lane shape point of the plurality of lane shape points 313b determined on the first boundary 311b may correspond to a lane shape point of the plurality of lane shape points 313b determined on the second boundary 311c of the generated bounding path 311a. For example, a first lane shape point on the first boundary 311b may correspond to a first lane shape point on the second boundary 311c. Similarly, a second lane shape point on the first boundary 311b may correspond to a second lane shape point on the second boundary 311c. Thus, a lane shape point on the first boundary 311b and a lane shape point on the second boundary 311c may form a node pair.

In some embodiments, each lane shape point of the plurality of lane shape points 313b may correspond to a latitude, a longitude, and an altitude. Each lane shape point may represent the latitude, the longitude and the altitude corresponding to the location on the map of the traffic signal intersection 301a. Such plurality of lane shape points 313b may be utilized to define a distance within which the vehicle 301b may maintain the trajectory while travelling between the lane pair 305a.

In some embodiments, the generation of the virtual lane 313a may be further based on a determination of a lane curvature associated with the generated bounding path 311a. The lane curvature may be a curve that may be required to switch from the ingress lane 305b to the egress lane 305c of the lane pair 305a by the vehicle 301b. The processor 201 may determine the lane curvature associated with the generated bounding path 311a for the generation of the virtual lane 313a. For example, the one or more vehicles may require travelling in a curved path to switch from the ingress lane 305b to the egress lane 305c. Such lane curvature may be utilized for the generation of the virtual lane 313a for the vehicle 301b.

At 315, data associated with the generated virtual lane 313b may be stored in the map database 103a. The data associated with the generated virtual lane 313b may be utilized by the vehicle 301b to maintain the desired trajectory while travelling between the ingress lane 305b and the egress lane 305c of the lane pair 305a.

In some embodiments, map data may be updated to prevent vehicles from changing modes at the traffic signal intersection 301a. For example, the map data stored in the map database 103a may be updated based on the generated virtual lane 313a. Such updated map data may be transmitted to the AVs, such as the vehicle 301b to prevent changing modes of driving. In an embodiment, vehicles may have the different modes of driving based on different levels of automation. For example, a level “0” mode vehicle may issue automated warnings but needs a driver for control of the vehicle. A level “1” or “hands-on” mode vehicle may provide automated controls, such as speed control and parking assistance, however the driver needs to control the steering of the vehicle. A level “2” or “hands-off” mode vehicle may provide full control of the vehicle, such as accelerating, braking, and steering, however the driver needs to be prepared for intervention in case the automated control fails. A level “3” or “eyes-off” mode vehicle may be capable of handling situations that call for an immediate response, such as emergency braking. A level “4” or “mind-off” mode vehicle may require no attention of the driver for safety in situations such as traffic jams. A level “5” or “steering wheel optional” mode vehicle may provide fully automated driving experience to the driver. Conventionally, at the traffic signal intersection 301a the vehicle 301b may require changing mode of driving for enhanced safety. For example, the vehicle 301b may change the mode of driving from the level “4” mode to the level “3” mode to travel from the ingress lane 305b to the egress lane 305c of the lane pair 305a. However, the system 101 may enable prevention of the change in the mode of driving by updating the map data and providing the updated map data to the vehicle 301b for maintenance of the trajectory within the virtual lane 313a.

In some embodiments, the processor 201 may be configured to transmit the data associated with the generated virtual lane 313a to the vehicle 301b. For example, the data may be the updated map data stored in the map database 103a. The processor 201 may retrieve sensor data associated with the vehicle 301b. The sensor data may be utilized for autonomous driving of the vehicle 301b. In some embodiments, the retrieved sensor data may be associated with at least one of a camera, the LiDAR system, the RADAR system, or the GPS. The camera may be utilized by the vehicle 301b to detect and capture nearby objects, such as nearby vehicles while travelling. The LiDAR system may be used by the vehicle 301b to determine a distance between the vehicle 301b and the nearby objects, such as nearby vehicles, pedestrians, and so forth. The RADAR system may be utilized by the vehicle 301b for collision avoidance, the pedestrian detection, cyclist detection and the like. The GPS may be utilized by the vehicle 301b to determine the real-time location of the vehicle 301b. The processor 201 may further utilize the data associated with the generated virtual lane 313a and the retrieved sensor data for maintenance of the trajectory of the vehicle 301b within the generated virtual lane 313a. The sensor data along with the generated virtual lane 313a may be utilized by the vehicle 301b to maintain the trajectory within the virtual lane 313a for safe travel at the traffic signal intersection 301a.

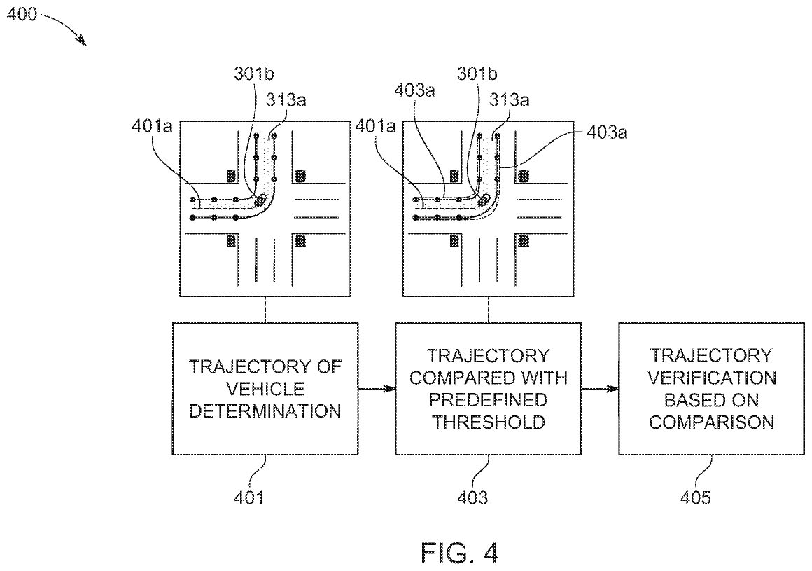

FIG. 4 illustrates an exemplary diagram 400 depicting steps to be performed for verification of the trajectory of the vehicle 301b, in accordance with an example embodiment. FIG. 4 is described in conjunction with elements from FIG. 1, FIG. 2A, FIG. 2B, FIG. 2C, FIG. 2D, FIG. 3A and FIG. 3B. FIG. 4 include steps 401 to 405. It will be understood that one or more steps of the exemplary diagram 400, and combinations of steps in the exemplary diagram 400, may be implemented by special purpose hardware-based computer systems which perform the specified functions, or combinations of special purpose hardware and computer instructions. The steps illustrated by the exemplary diagram 400 is used for generation of the virtual lane. Fewer, more, or different steps may be provided.

At step 401, a trajectory 401a of the vehicle 301b travelling between the lane pair 305a may be determined. In some embodiments, the processor 201 may be configured to determine the trajectory 401a of the vehicle 301b travelling between the lane pair 305a. The trajectory 401a may be the path followed by the vehicle 301b to travel from the ingress lane 305b to the egress lane 305c of the lane pair 305a. In an embodiment, the vehicle 301b may receive the data associate with the generated virtual lane 313a to maintain the trajectory 401a. The vehicle 301b may utilize the plurality of lane shape points 313b of the generated virtual lane 313a to maintain the trajectory 401a. For example, the trajectory 401a of the vehicle 301b may be determined by use of the GPS data retrieved from the GPS associated with the vehicle 301b.

At 403, the determined trajectory 401a of the vehicle 301b may be compared with a predefined threshold 403a associated with the generated virtual lane 313a. In some embodiments, the processor 201 may be configured to compare the determined trajectory 401a of the vehicle 301b with the predefined threshold 403a associated with the generated virtual lane 313a. The predefined threshold 403a may be associated with the bounding path 311a of the generated virtual lane 313a. For example, the predefined threshold 403a may be predefined extremities close to the first boundary 311b and the second boundary 311c of the bounding path 311a of the generated virtual lane 313a. The predefined threshold 403a may determine a distance within which the trajectory 401a of the vehicle 301b may require to be.

At 405, the processor 201 may verify the determined trajectory 401a of the vehicle 301b to be within the generated virtual lane 313a, based on the comparison. The processor 201 may compare the determined trajectory 401a of the vehicle 301b with the predefined threshold 403a to determine the trajectory 401a of the vehicle 301b to be within the virtual lane 313a. Thus, in such a manner the trajectory 401a of the vehicle 301b may be verified to be within the generated virtual lane 313a. In other words, the generated virtual lane 313a may be verified as an accurate path of travel for the vehicle 301b.

In some embodiments, the processor 201 may detect an abnormal trajectory 401a of the vehicle 301b, based on a determination that the determined trajectory 401a of the vehicle 301b may be outside the predefined threshold 403a associated with the generated virtual lane 313a. In certain scenarios, the vehicle 301b may be unable to maintain the desired trajectory 401a in the generated virtual lane 313a. In such cases, the trajectory 401a of the vehicle 301b may be determined to be abnormal (or undesired). The processor 201 may generate a notification based on the detected abnormal trajectory 401a of the vehicle 301b. The notification may include information about the abnormal trajectory 401a of the vehicle 301b. The generated notification may be sent to a server associated with the vehicle 301b. In some cases, the vehicle 301b may again be provided with the data associated with the generated virtual lane 313a to correct the abnormal trajectory 401a of the vehicle 301b.

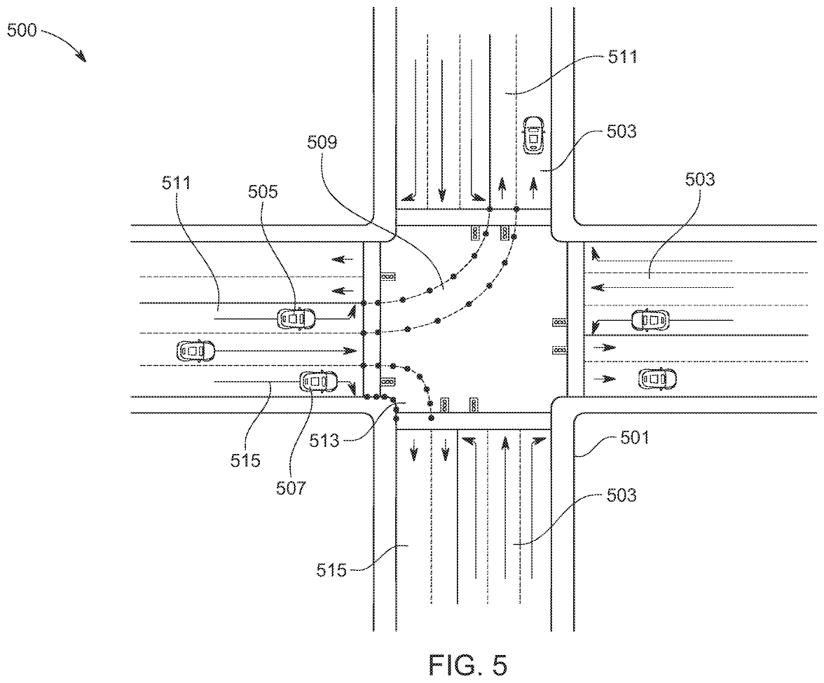

FIG. 5 illustrates an exemplary scenario 500 for generation of the virtual lane for vehicles passing through a traffic signal intersection, in accordance with an example embodiment. FIG. 5 is described in conjunction with elements from FIG. 1, FIG. 2A, FIG. 2B, FIG. 2C, FIG. 2D, FIG. 3A, FIG. 3B and FIG. 4.

The exemplary scenario 500 may include a traffic signal intersection 501. The traffic signal intersection 501 may include a plurality of lanes 503. A plurality of vehicles may pass through the traffic signal intersection 501. The plurality of vehicles, such as a first vehicle 505 may be present in a first ingress lane and a second vehicle 507 may be present in a second ingress lane of the plurality of lanes 503.

The processor 201 may be configured to generate a first virtual lane 509 for the first vehicle 505 that may be present in the first ingress lane of a first lane pair 511 of the plurality of lanes 503. The first vehicle 505 may need to travel in the first egress lane of the first lane pair 511 of the plurality of lanes 503. The processor 201 may generate the first virtual lane 509 based on the historical sensor data passed through the first lane pair 511, the SPaT data and the map data associated with the traffic signal intersection 501.

Similarly, the processor 201 may be configured to generate a second virtual lane 513 for the second vehicle 507 that may be present in the second ingress lane of a second lane pair 515 of the plurality of lanes 503. The second vehicle 507 may need to travel in the second egress lane of the second lane pair 515 of the plurality of lanes 503. The processor 201 may generate the second virtual lane 513 based on the historical sensor data passed through the second lane pair 515, the SPaT data and the map data associated with the traffic signal intersection 501. Similarly, the processor 201 may be configured to generate the virtual lane for each vehicle at the traffic signal intersection 501 for safe movement of the vehicles.

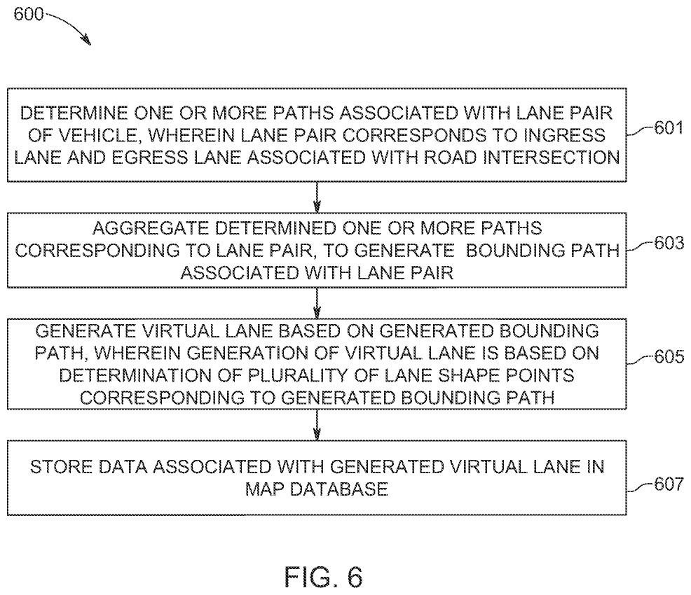

FIG. 6 illustrates a flow diagram of a method for generation of a virtual lane, in accordance with an example embodiment. It will be understood that each block of the flow diagram of the method 600 may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory 203 of the system 101, employing an embodiment of the present invention and executed by a processor 201. As will be appreciated, any such computer program instructions may be loaded onto a computer or other programmable apparatus (for example, hardware) to produce a machine, such that the resulting computer or other programmable apparatus implements the functions specified in the flow diagram blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flow diagram blocks.

Accordingly, blocks of the flow diagram support combinations of means for performing the specified functions and combinations of operations for performing the specified functions for performing the specified functions. It will also be understood that one or more blocks of the flow diagram, and combinations of blocks in the flow diagram, may be implemented by special purpose hardware-based computer systems which perform the specified functions, or combinations of special purpose hardware and computer instructions. The method 600 illustrated by the flowchart diagram of FIG. 6 is used for generation of the virtual lane. Fewer, more, or different steps may be provided.

At step 601, the method 600 comprises determining one or more paths 309a associated with the lane pair 305a of the vehicle 301b. The lane pair 305a may correspond to the ingress lane 305b and the egress lane 305c associated with a road intersection. In an embodiment, the road intersection is the traffic signal intersection 301a. The one or more paths 309a may correspond to the trajectory of the one or more vehicles passed through the lane pair 305a. The historical sensor data associated with the one or more vehicles passed through the lane pair 305a may be utilized to determine the one or more paths 309a. Details of the determination of the one or more paths 309a are further described, for example, in FIGS. 3A and 3B.

At step 603, the method 600 comprises aggregating the determined one or more paths 309a corresponding to the lane pair 305a, to generate the bounding path 311a associated with the lane pair 305a. The bounding path 311a may further include the first boundary 311b and the second boundary 311c. Details of the generation of the bounding path 311a are further described, for example, in FIG. 3B.

At step 605, the method 600 comprises generating the virtual lane 313a based on the generated bounding path 311a. The generation of the virtual lane 313a may be based on determination of the plurality of lane shape points 313b corresponding to the generated bounding path 311a. In some embodiments, the generation of the virtual lane 313a may be further based on the determination of the lane curvature associated with the generated bounding path 311a. Details of the generation of the virtual lane 313a are further described, for example, in FIG. 3B.

At step 607, the method 600 comprises storing data associated with the generated virtual lane 313a in the map database 103a. In some embodiments, the map data is updated to prevent the vehicles from changing modes at the traffic signal intersection 301a. The data associated with the generated virtual lane 313a may be further utilized for maintenance of the trajectory 401a of the vehicle 301b within the generated virtual lane 313a. Details of the storage of the data associated with the generated virtual lane 313a in the map database 103a are further described, for example, in FIG. 3B.

The method 600 may be implemented using corresponding circuitry. For example, the method 600 may be implemented by an apparatus or system comprising a processor, a memory, and a communication interface of the kind discussed in conjunction with FIG. 2A.

In some embodiments, the road intersection may be the traffic signal intersection 301a.

In some embodiments, the method further comprises identifying the traffic signal intersection. The method further comprises retrieving the SPaT data and map data associated with the identified traffic signal intersection. The method further comprises determining the lane pair based on the retrieved SPaT data and the map data. The method further comprises retrieving the historical sensor data associated with one or more vehicles passed through the determined lane pair. The method further comprises performing map matching of the retrieved historical sensor data and the determined lane pair to determine the one or more paths associated with the lane pair of the vehicle.

In some embodiments, the method further comprises generation of the virtual lane is further based on determination of the lane curvature associated with the generated bounding path.

In some embodiments, the generated bounding path may further comprise a first boundary and a second boundary. Each lane shape point of the plurality of lane shape points determined on the first boundary may correspond to the lane shape point of the plurality of lane shape points determined on the second boundary of the generated bounding path.

In some embodiments, each lane shape point of the plurality of lane shape points corresponds to the latitude, the longitude, and the altitude.

In some embodiments, the method further comprises transmitting the data associated with the generated virtual lane to the vehicle. The method further comprises retrieving sensor data associated with the vehicle. The method further comprises utilizing the data associated with the generated virtual lane and the retrieved sensor data for maintenance of a trajectory of the vehicle within the generated virtual lane.

In some embodiments, the retrieved sensor data may be associated with at least one of the camera, the LiDAR system, the RADAR system, or the GPS.

In some embodiments, the method further comprises determining the trajectory of the vehicle travelling between the lane pair. The method further comprises comparing the determined trajectory of the vehicle with the predefined threshold associated with the generated virtual lane. The method further comprises verifying the determined trajectory of the vehicle to be within the generated virtual lane, based on the comparison.

In some example embodiments, a computer programmable product may be provided. The computer programmable product may comprise at least one non-transitory computer-readable storage medium having stored thereon computer-executable program code instructions that when executed by a computer, cause the computer to execute the method 600.

In an example embodiment, an apparatus for performing the method 600 of FIG. 6 above may comprise a processor (e.g. the processor 201) configured to perform some or each of the operations of the method of FIG. 6 described previously. The processor may, for example, be configured to perform the operations (601-607) by performing hardware implemented logical functions, executing stored instructions, or executing algorithms for performing each of the operations. Alternatively, the apparatus may comprise means for performing each of the operations described above. In this regard, according to an example embodiment, examples of means for performing operations (601-607) may comprise, for example, the processor 201 which may be implemented in the system 101 and/or a device or circuit for executing instructions or executing an algorithm for processing information as described above.

In this way, example embodiments of the invention results in generation of the virtual lane and verification of the trajectory of the vehicle to be within the virtual lane, that may be beneficial for reduction of risk of accidents at the traffic signal intersection. The invention also allows update of the map database based on the generated virtual lane.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

We claim:

1. A system for virtual lane generation for a vehicle, the system comprising:
at least one non-transitory memory configured to store computer-executable instructions; and
at least one processor configured to execute the computer-executable instructions to:
determine one or more paths associated with a lane pair of the vehicle, wherein the lane pair corresponds to an ingress lane and an egress lane associated with a traffic signal intersection;
aggregate the determined one or more paths corresponding to the lane pair, to generate a bounding path associated with the lane pair;
generate a virtual lane based on the generated bounding path, wherein the generation of the virtual lane is based on determination of a plurality of lane shape points corresponding to the generated bounding path; and
store data associated with the generated virtual lane in a map database.

2. The system of claim 1, wherein the at least one processor is further configured to:
identify the traffic signal intersection;
retrieve signal phase and timing (SPaT) data and map data associated with the identified traffic signal intersection;
determine the lane pair based on the retrieved SPaT data and the map data;
retrieve historical sensor data associated with one or more vehicles passed through the determined lane pair; and
perform map matching of the retrieved historical sensor data and the determined lane pair to determine the one or more paths associated with the lane pair of the vehicle.

3. The system of claim 1, wherein the generation of the virtual lane is further based on a determination of a lane curvature associated with the generated bounding path.

4. The system of claim 1, wherein the generated bounding path further comprises a first boundary and a second boundary, and wherein each lane shape point of the plurality of lane shape points determined on the first boundary corresponds to a lane shape point of the plurality of lane shape points determined on the second boundary of the generated bounding path.

5. The system of claim 1, wherein each lane shape point of the plurality of lane shape points corresponds to a latitude, a longitude, and an altitude.

6. The system of claim 1, wherein the at least one processor is further configured to:
transmit the data associated with the generated virtual lane to the vehicle;
retrieve sensor data associated with the vehicle; and
utilize the data associated with the generated virtual lane and the retrieved sensor data for maintenance of a trajectory of the vehicle within the generated virtual lane.

7. The system of claim 6, wherein the retrieved sensor data is associated with at least one of: a camera, a Light Detection and Ranging (LiDAR) system, a radio detection and ranging (RADAR) system, or a global positioning system (GPS).

8. The system of claim 1, wherein the at least one processor is further configured to:
determine a trajectory of the vehicle travelling between the lane pair;
compare the determined trajectory of the vehicle with a predefined threshold associated with the generated virtual lane; and
verify the determined trajectory of the vehicle to be within the generated virtual lane, based on the comparison.

9. The system of claim 8, wherein the at least one processor is further configured to:
detect an abnormal trajectory of the vehicle, based on a determination that the determined trajectory of the vehicle is outside the predefined threshold associated with the generated virtual lane; and
generate a notification based on the detected abnormal trajectory of the vehicle.

10. The system of claim 1, the one or more processor is further configured to update map data to prevent vehicles from changing modes at the traffic signal intersection.

11. A method, comprising:
determining one or more paths associated with a lane pair of the vehicle, wherein the lane pair corresponds to an ingress lane and an egress lane associated with a road intersection;
aggregating the determined one or more paths corresponding to the lane pair, to generate a bounding path associated with the lane pair;
generating a virtual lane based on the generated bounding path, wherein the generation of the virtual lane is based on determination of a plurality of lane shape points corresponding to the generated bounding path; and
storing data associated with the generated virtual lane in a map database.

12. The method of claim 11, wherein the road intersection is a traffic signal intersection.

13. The method of claim 11, further comprising:
identifying the road intersection;
retrieving signal phase and timing (SPaT) data and map data associated with the identified road intersection;
determining the lane pair based on the retrieved SPaT data and the map data;
retrieving historical sensor data associated with one or more vehicles passed through the determined lane pair; and
performing map matching of the retrieved historical sensor data and the determined lane pair to determine the one or more paths associated with the lane pair of the vehicle.

14. The method of claim 11, wherein the generation of the virtual lane is further based on determination of a lane curvature associated with the generated bounding path.

15. The method of claim 11, wherein the generated bounding path further comprises a first boundary and a second boundary, and wherein each lane shape point of the plurality of lane shape points determined on the first boundary corresponds to a lane shape point of the plurality of lane shape points determined on the second boundary of the generated bounding path.

16. The method of claim 11, wherein each lane shape point of the plurality of lane shape points corresponds to a latitude, a longitude, and an altitude.

17. The method of claim 11, further comprising:
transmitting the data associated with the generated virtual lane to the vehicle;
retrieving sensor data associated with the vehicle; and
utilizing the data associated with the generated virtual lane and the retrieved sensor data for maintenance of a trajectory of the vehicle within the generated virtual lane.

18. The method of claim 17, wherein the retrieved sensor data is associated with at least one of: a camera, a Light Detection and Ranging (LiDAR) system, a radio detection and ranging (RADAR) system, or a global positioning system (GPS).

19. The method of claim 11, further comprising:
determining a trajectory of the vehicle travelling between the lane pair;
comparing the determined trajectory of the vehicle with a predefined threshold associated with the generated virtual lane; and
verifying the determined trajectory of the vehicle to be within the generated virtual lane, based on the comparison.

20. A computer program product comprising a non-transitory computer readable medium having stored thereon computer executable instructions which when executed by at least one processor, cause the processor to conduct operations for virtual lane generation for a vehicle, the operations comprising:
determining one or more paths associated with a lane pair of the vehicle, wherein the lane pair corresponds to an ingress lane and an egress lane associated with a traffic signal intersection;
aggregating the determined one or more paths corresponding to the lane pair, to generate a bounding path associated with the lane pair;
generating a virtual lane based on the generated bounding path, wherein the generation of the virtual lane is based on determination of a plurality of lane shape points corresponding to the generated bounding path; and
storing data associated with the generated virtual lane in a map database.
